(19) United States
(12) Patent Application Publication
(10) Pub. No.: US 2005/0241605 A1
(43) Pub. Date: Nov. 3, 2005

(54) Fluid flow surface with indentations

(76) Inventors: Donald R. Bedwell, Columbia City, IN (US); Robert John Frendak, Parma, OH (US); Debra Veneau, Parma, OH (US)

Correspondence Address: ST. ONGE STEWARD JOHNSTON & REENS, LLC, 986 BEDFORD STREET, STAMFORD, CT, 06905-5619, US

(21) Appl. No.: 10/834,803

(22) Filed: Apr. 29, 2004

(51) Int. Cl. F02M 35/10

(52) U.S. Cl. 123/184.21; 138/37

(57) ABSTRACT

A tube or conduit for conducting a flow of fluid such as is used in connection with an engine, the tube or conduit having a flow surface with a plurality of indentations spaced apart from each other such that a fluid layer is formed across the surface, the fluid layer insulating the fluid from ambient heating and lower the resistance faced by the fluid such that a larger volume of fluid reaches the engine at a given time to thereby increase engine output.

### FIELD OF THE INVENTION

The invention relates to a system and method for creating a fluid layer in a conduit to insulate and increase fluid flow in the conduit, and in particular to a system and method for providing lower temperature fluid and a greater volume of fluid to an engine.

### BACKGROUND OF THE INVENTION

In the field of high performance vehicles, the ability to enhance the engine performance, even by a relatively small amount, can make a large difference in the outcome of a race. As such, any advantage obtained by a competitor may mean the difference between winning and losing.

As such, many efforts have been made to maximize vehicle engine performance. This may be accomplished in many ways such as for instance, providing a larger and more powerful engine, and/or maximizing the horsepower output by the engine.

To maximize horsepower in a combustion engine, it is importance to provide an adequate level of both fuel and combustion air. Providing larger quantities of combustion air increases engine horsepower by providing more fuel combustion. Providing lower temperature combustion air also increases engine horsepower because cooler air is denser than warmer air thereby providing for more fuel combustion. In addition, with an increase in combustion air flow, larger quantities of fuel may be utilized again increasing engine horsepower. It is therefore desirable to maximize fluid flow both in the combustion air flow and in the fuel flow to the engine.

There are a number of ways this may be accomplished, for instance, fluid lines may be made larger thereby presenting lower resistance to fluid flow and/or the fluid may be accelerated through the lines at a higher velocity such as for instance, with a super charger or a turbo charger. However, space limitations and mechanical limitations restrict use of both these methods.

A number of patents have disclosed various systems and methods for increasing fuel burning efficiency. For instance, U.S. Pat. No. 6,319,458 to Jung et al. (“the '458 patent”) discloses a pulverized coal injecting apparatus using an outer pipe and an inner pipe with a spiral swirler and depressions formed on an inner surface of a leading end portion to improve the mixing of pulverized coal with combustible fluid for a blast furnace. The '458 patent teaches that dimples are provided on the inner pipe to facilitate turbulence for the efficient mixing of the pulverized coal with the combustible fluid. However, the '458 patent fails to teach delivering more fluid through the conduit or providing a lower temperature fluid to the furnace.

Other patents disclose systems for use with combustion engines. For instance, U.S. Pat. No. 5,970,963 to Nakase et al. (“the '963 patent”) discloses an apparatus for suppressing the flow noise caused at the time of opening of a throttle valve. Dimples are provided for a very short distance immediately downstream of a throttle valve to prevent the two air flows moving around each end of the throttle valve from converging, which the '963 patent submits decreases noise. However, the '963 patent fails to teach delivering more fluid through the conduit or providing a lower temperature fluid to the combustion engine. Rather, as the dimples are limited to only a very short portion of the conduit immediately after the throttle valve to generate a local turbulence such that the flows of air around the ends of the throttle valve are pulled away from each other to decrease noise according to the operation of the throttle valve. While the '963 patent may decrease fluid flow noise in and around the throttle valve, it cannot deliver more fluid through the conduit or providing a lower temperature fluid to the combustion engine.

Still other patents have disclosed various systems and methods for reducing the pressure in a water pipe such that a smaller diameter pipe may be utilized to deliver that same amount of water. For instance, U.S. Pat. No. 5,378,524 to Blood (“the '524 patent”) discloses an internal surface of a pipe comprising a matrix of dimples formed into the surface. The '524 patent fails however to teach providing a lower temperature fluid to an engine or providing a larger quantity of fluid to an engine.

Therefore what is desired is a system and method for increasing engine horsepower.

It is further desired to provide a system and method for providing a fluid to an engine through a tube where heating of the fluid by ambient heat is reduced.

It is still further desired to provide a system and method for increasing the flow rate of a fluid to an engine through a tube to provide a larger quantity of fluid to the engine.

It is yet further desired to provide a system and method for increasing the flow rate of a fluid from an engine through a tube to remove a larger quantity of fluid from the engine.

### SUMMARY OF THE INVENTION

These and other objectives are achieved by minimizing factors that tend to lower engine performance such as fluid flow resistance and temperature rise in intake and output tubes or conduits. As previously mentioned, increasing fluid flow such as for instance, air flow and/or fuel flow, to an engine is one way to increase the engine output. Another way to increase engine output is to provide lower temperature fluid to engine as the fluid is denser which provides greater engine efficiency.

In one advantageous embodiment an engine fluid flow path system for insulating a fluid from heat generated by an engine is provided comprising an intake system for transferring the fluid from atmosphere into the engine, the intake system including an induction tube having a surface with a plurality of indentations spaced apart from each other. The system is further provided such that said plurality of indentations extend along a length of the surface to an extent that when a flow of fluid is introduced over the surface, a fluid layer is formed by fluid proximate to the indentations and caused by the presence of the indentations, the fluid layer insulating the flow of fluid from ambient heat such that any elevation in temperature of the fluid is reduced.

In another advantageous embodiment an engine fluid flow path system for reducing friction of a fluid flowing along a flow path is provided comprising an engine having an intake system for transferring the fluid from the atmosphere to the engine, the intake system including an induction tube having a surface with a plurality of indentations spaced apart from each other. The system is further provided such that said plurality of indentations extending along a length of the surface to an extent that when a flow of fluid is introduced over the surface, a fluid layer is formed by fluid proximate to the indentations and caused by the presence of the indentations, the fluid layer reducing fluid flow resistance in the induction tube such that resistance to the fluid flow over the surface is reduced and the volume of fluid flowing over the surface at a given time is increased.

In still another advantageous embodiment a method for insulating a fluid from heat generated by an engine is provided comprising the steps of connecting an induction tube from atmosphere to an engine, and providing a plurality of indentations spaced apart from each other on a surface of the induction tube. The method further comprises the steps of drawing a flow of fluid over the surface, forming a fluid layer of air proximate to the indentations when the fluid flows over the surface, and insulating the flow of fluid from ambient heat such that any elevation in temperature of the fluid is reduced.

In yet another advantageous embodiment an engine fluid flow path system for insulating a fluid from heat generated by an engine is provided comprising an intake system for transferring the fluid from atmosphere into the engine, the intake system including an induction tube having a surface with a plurality of indentations spaced apart from each other. The system further comprises a flow of fluid over the surface, and a fluid layer formed by air proximate to the indentations and caused by the presence of the indentations when the fluid flows over the surface, the fluid layer insulating the flow of fluid from ambient heat such that any elevation in temperature of the fluid is reduced.

The invention and its particular features and advantages will become more apparent form the following detailed description considered with reference to the accompanying drawings.

### BRIEF DESCRIPTION OF THE DRAWINGS

FIG. 1 is a cross-sectional illustration of a tube with a fluid flowing therethrough according to one advantageous embodiment of the present invention.

FIG. 2 is a perspective view of the tube according to FIG. 1.

FIG. 3 is an enlarged view of an indentation according to FIG. 1.

FIG. 4 is an enlarged view of the surface of the tube according to FIG. 1 showing the spacing of the indentations across the surface.

FIG. 5 is a block diagram illustrating the advantageous embodiment of the present invention according to FIG. 1.

FIG. 6 is a block diagram according to FIG. 5 illustrating the intake system in greater detail.

FIG. 7 is a block diagram according to FIG. 5 illustrating the exhaust system in greater detail.

FIG. 8 is an illustration of the embodiment according to FIG. 5.

### DETAILED DESCRIPTION OF THE DRAWINGS

Referring now to the drawings, wherein like reference numerals designate corresponding structure throughout the views.

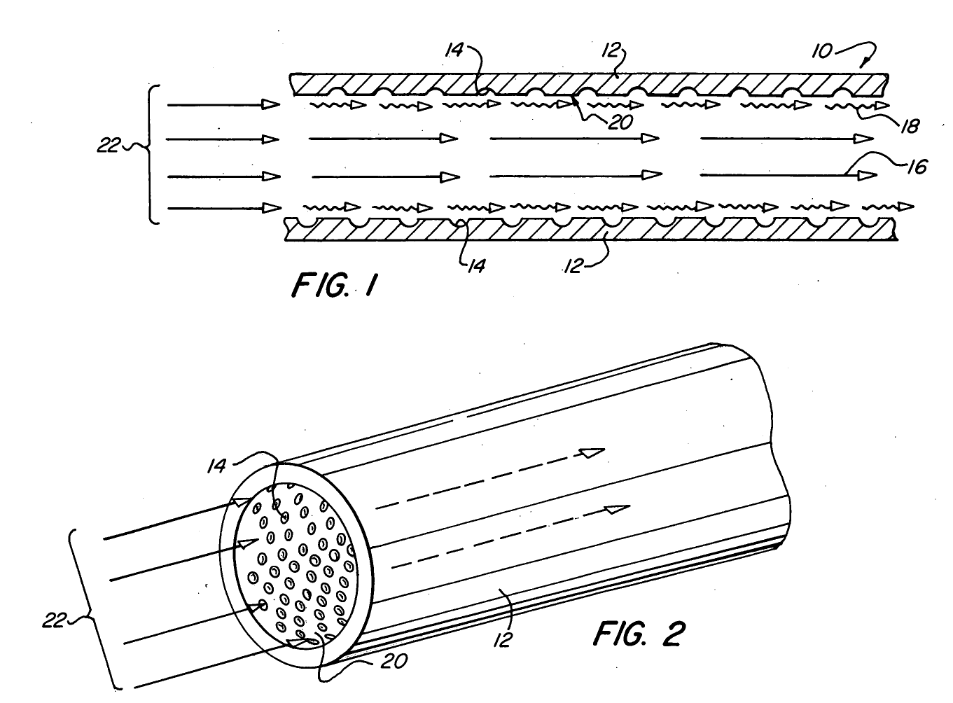

FIG. 1 is an illustration of cross-sectional view of a tube 10 having walls 12 and inner surface 20, while FIG. 2 is a perspective view of tube 10. Tube 10 may comprise any suitable material such as for instance but not limited to, a metal or metallic composite, a rigid or flexible plastic or polymer, a flexible rubber material, or combinations thereof. Tube 10 may be any fluid line as used with an engine (not shown) such as for instance, an air line, fuel line, water or antifreeze line, or any other fluid line.

Provided in surface 20 are indentations 14, which are spaced apart from each other a regular intervals to form a pattern over surface 20. A fluid 22 is introduced into tube 10 and flows down a length of tube 10. Fluid 22 encounters resistance in tube 10, which results in a pressure drop of the fluid due to the encountered resistance.

Pressure drop attributed to resistance of the conduit may be calculated by means of a well-known equation entitled Darcy's Formula which states:
ΔP=(ρ)(f)(L)(v²)/(288)(D)(g) (equation 1)
Where ΔP is pressure loss due to friction in the conduit; ρ is the density of the fluid; f is the friction factor; L is the length of the conduit; v is the velocity of the fluid; D is the diameter of the conduit (I.D.); and g is gravity. In one advantageous embodiment of the present application, the friction factor (f) is reduced to increase fluid flow volume, while in another aspect of the present application the fluid is insulated from heating such that cooler, denser air which also correlates to an increased flow volume is realized.

The fluid 22 depicted by the four solid arrows enters tube 10 and encounter indentations 14 dispersed on the surface 20. The fluid interacts with the indentations 14 such that a layer 18 is formed in and around indentations 14 and across surface 20. A fluid flow 16 moves down a center of tube 10 at a higher speed relative to layer 18 such that the resistance encountered by fluid 22 is reduced. In addition, when fluid 22 comprises for instance air, layer 18 acts as an insulating layer relative to fluid flow 16 such temperature elevation of fluid flow 16 from ambient heating is reduced.

Both of these benefits as realized for high performance engines can translate into a large benefit in engine output. For instance, a 3° F. drop in combustion air temperature into the engine translates into as much as a 10 Hp increase in engine output. By reducing resistance to the fluid flow which increases the volume of air reaching the engine and by insulating the combustion air flow from ambient heat to provide cooler air and therefore denser air (more volume), significant increases in engine output may be realized.

While tube 10 as depicted in FIG. 2 is illustrated as having a round cross-section, it is contemplated that tube 10 may comprise many differing cross-sectional shapes as desired depending upon the application. For instance, as utilized in an air intake for combustion air, the cross-sectional shape may vary widely.

As can be seen from viewing FIGS. 3 & 4, indentations 14 are preferably semi-spherical, dispersed apart from each other in a pattern across surface 20. The size and shape may vary, but in a preferred embodiment are as disclosed in FIG. 3 with indentation 14 having a diameter of 0.150 mm and a cavity depth of 0.010 mm. However, it should be noted that, the diameter of indentations 14 may range of from about 0.050 mm to about 0.250 mm, with a cavity depth in a range of from about 0.005 mm to about 0.030 mm.

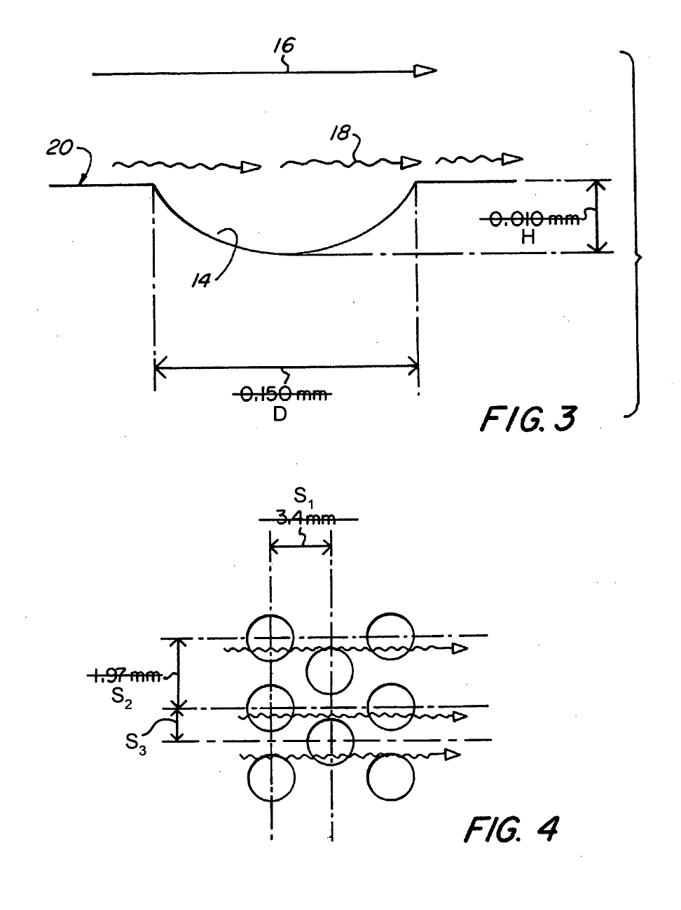

It can be seen in FIG. 4 that indentations 14 overlap one another in the direction of fluid flow 16 but do not overlap one another in the direction perpendicular to fluid flow 16. For instance, a center-to-center measurement of indentations 14 in the direction of fluid flow 16 comprises in a preferred embodiment 3.4 mm, whereas a center-to-center measurement of indentations 14 in a direction perpendicular to fluid flow 16 comprises in a preferred embodiment 1.97 mm. It should be noted however that the pattern spacing may vary depending upon the circumference/diameter and/or height of surface 20. Typically the spacing of indentations 14 in the direction of fluid flow 16 is in a range of from about 0.150 mm to about 0.400 mm, while the spacing of indentations 14 in a direction perpendicular to fluid flow 16 is in a range of from about 0.070 mm to about 0.250 mm.

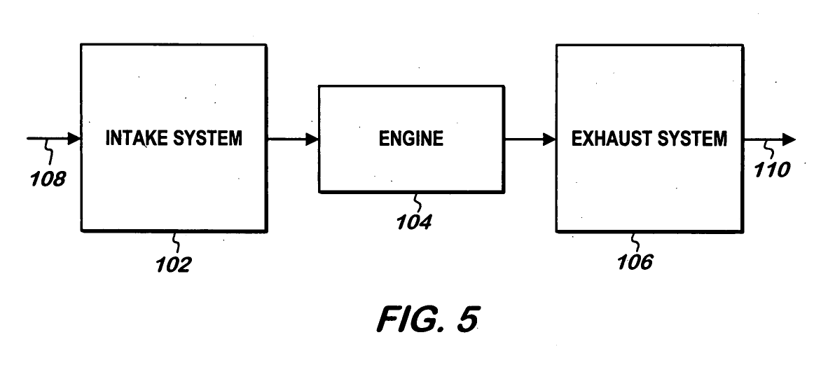

FIG. 5 is a block diagram of one advantageous embodiment of the present invention illustrating a fluid flow system for an engine 100 comprising input fluid 108, intake system 102, manifold 104, exhaust system 106 and exhaust fluid 110. Input fluid 108 may comprise for instance, combustion air for use in a combustion engine (not shown). Intake system 102 may also comprise for instance, means for gathering input air 108 and for transporting input air 108 to engine 104, while exhaust system 106 may comprise means for removing exhaust air 110 from engine 104.

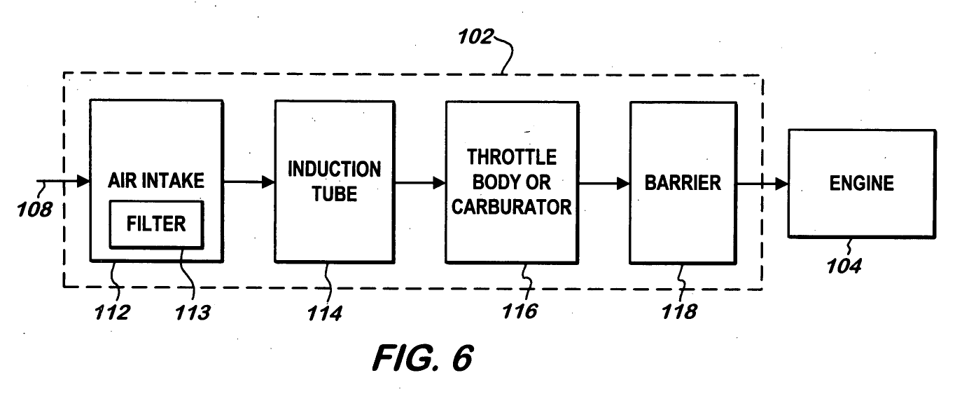

The following description relating to one advantageous embodiment of the present invention is made in reference to FIGS. 6-8. Referring now to FIGS. 6 and 8, intake system 102 is illustrated in greater detail comprising air intake 112, induction tube 114, throttle body or carburetor 116, and barrier 118. Air intake 112 may comprise any type of air gathering system typically comprising a relatively large opening positioned toward the front of the vehicle such that a positive pressure is created as the vehicle moves forward. The opening is typically attached to a conduit that funnels input air 108 into induction tube 114. In addition, air intake 112 will typically further comprise a filter 113 for filtering input air 108 such that contaminates are not introduced into engine 104. The surface of air intake 112 may be provided with the indentations as previously described in connection with FIGS. 1-4.

Induction tube 114 transports the input air 108 from the air intake to the throttle body or carburetor 116 and is also provided with the indentations are previously described. The distance of induction tube 114 will vary from vehicle to vehicle such that generation of the fluid layer to insulate and reduce fluid resistance provides a significant advantage especially in high-performance vehicles.

Input air 108 is then introduced into throttle body or carburetor 116 where it is mixed with fuel. It is further contemplated that the walls of the throttle body or carburetor 116 that define the flow path of input air 108 through throttle body or carburetor 116 may also comprise the indentations to further provide for increased air volume to engine 104. Barrier 118 is provided between throttle body or carburetor 116 and engine 104 and typically sits on the engine manifold to provide a thermal barrier.

Input air 108 is then introduced into engine 104. Typically input air 108 will proceed through an input valve (not shown) to a piston (not shown) and out an exhaust valve (not shown) for a combustion engine.

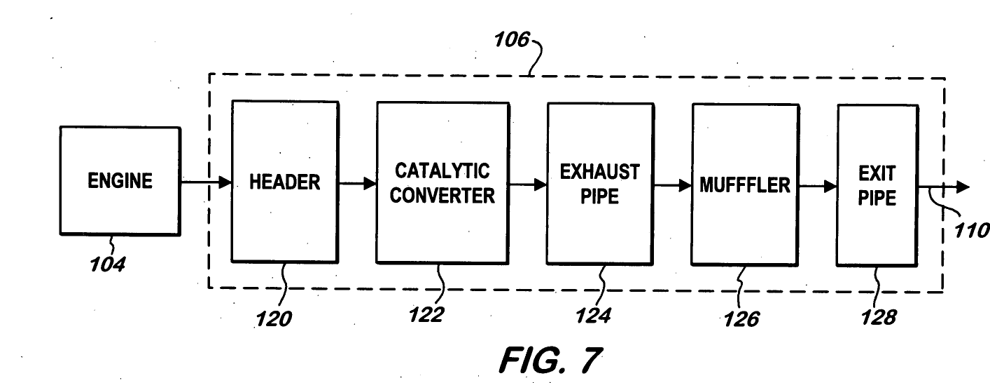

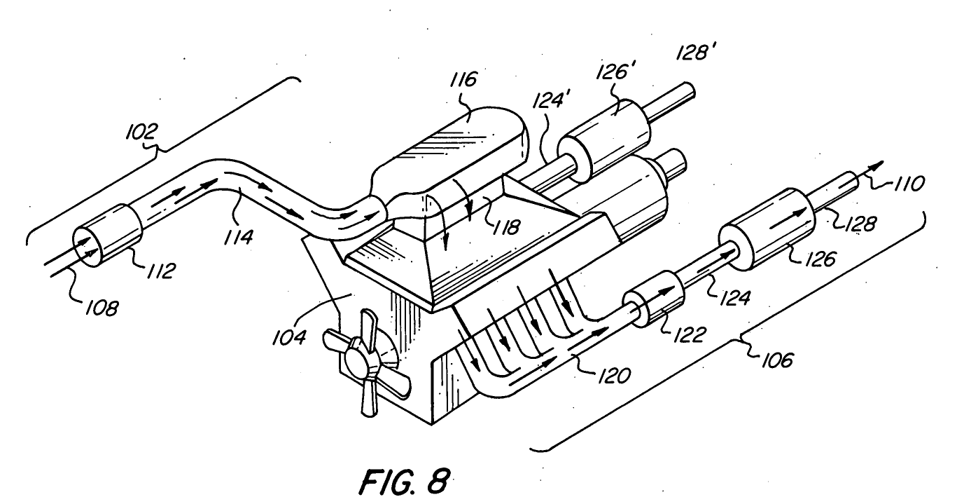

Referring now to FIGS. 7 and 8, exhaust air 110 is output from engine 104 as previously described and is received by header 120, which in this embodiment comprises four tubes or pipes as shown on one side of engine 104, but will vary from engine to engine. The surface of header 120 may be provided with the indentations as previously described in connection with FIGS.1-4. In this manner, a greater volume of exhaust air 110 may be drawn from engine 104, which will again increase engine 104 output.

Exhaust air 110 is then sent to catalytic converter 122, which in turn is connected to exhaust pipe 124. Indentations may also be provided in exhaust pipe 124 as described for header 120. Exhaust air 110 then moves through muffler 126 and out exit pipe 128 which may also comprise the indentations as previously described.

FIGS. 6-8 merely describe one advantageous embodiment of the present invention and it is contemplated that any number of the block references may be removed or rearranged in alternate order according to the application.

Although the invention has been described with reference to particular ingredients and formulations and the like, these are not intended to exhaust all possible arrangements or features, and indeed many other modifications and variations will be ascertainable to those of skill in the art.

1. An engine fluid flow path system for insulating a fluid from heat generated by an engine comprising:
an intake system for transferring the fluid from atmosphere into the engine, said intake system including an induction tube having a surface with a plurality of indentations spaced apart from each other; and
said plurality of indentations extending along a length of the surface to an extent that when a flow of fluid is introduced over the surface, a fluid layer is formed by fluid proximate to the indentations and caused by the presence of the indentations, the fluid layer insulating the flow of fluid from ambient heat such that any elevation in temperature of the fluid is reduced.

2. The engine fluid flow path system according to claim 1 wherein said surface is more than 25% covered by the indentations.

3. The engine fluid flow path system according to claim 1 wherein the flow of fluid comprises combustion air.

4. The engine fluid flow path system according to claim 1 further comprising a throttle body housing that partially defines the flow path.

5. The engine fluid flow path system according to claim 4 wherein the throttle body housing has a surface with a plurality of indentations spaced apart from each other.

6. The engine fluid flow path system according to claim 5 further comprising a barrier located between the throttle body housing and an engine manifold.

7. The engine fluid flow path system according to claim 6 wherein the barrier is provided with at least one opening to allow the fluid to pass from the throttle body housing to the engine manifold.

8. The engine fluid flow path system according to claim 7 wherein the at least one opening has a surface with a plurality of indentations spaced apart from each other.

9. The engine fluid flow path system according to claim 1 further comprising an exhaust system partially defining the engine fluid flow path.

10. The engine fluid flow path system according to claim 8 wherein said exhaust system comprises an exhaust pipe.

11. The engine fluid flow path system according to claim 10 wherein the exhaust pipe has a surface with a plurality of indentations spaced apart from each other.

12. The engine fluid flow path system according to claim 1 wherein said intake system further comprises an air intake.

13. The engine fluid flow path system according to claim 12 wherein said air intake has a surface with a plurality of indentations spaced apart from each other.

14. The engine fluid flow path system according to claim 12 wherein said air intake comprises a filter.

15. The engine fluid flow path system according to claim 14 wherein said filter has a surface with a plurality of indentations spaced apart from each other.

16. The engine fluid flow path system according to claim 1 further comprising a carburetor housing that partially defines the flow path.

17. The engine fluid flow path system according to claim 1 wherein the spacing of the indentations on the surface form a pattern.

18. The engine fluid flow path system according to claim 17 wherein the pattern spacing between indentations is longer in the direction of the longitudinal axis of the tube than the pattern spacing between indentations in a direction perpendicular to the longitudinal axis of the tube.

19. (canceled)

20. (canceled)

21. (canceled)

22. (canceled)

23. An engine fluid flow path system for reducing friction of a fluid flowing along a flow path comprising:
an engine having an intake system for transferring the fluid from the atmosphere to said engine, the intake system including an induction tube having a surface with a plurality of indentations spaced apart from each other; and
said plurality of indentations extending along a length of the surface to an extent that when a flow of fluid is introduced over the surface, a fluid layer is formed by fluid proximate to the indentations and caused by the presence of the indentations, the fluid layer reducing fluid flow resistance in the induction tube such that resistance to the fluid flow over the surface is reduced and the volume of fluid flowing over the surface at a given time is increased.

24. The engine fluid flow path system according to claim 23 wherein the fluid layer insulates the flow of fluid from ambient heat such that any elevation in temperature of the fluid is reduced.

25. The engine fluid flow path system according to claim 23 wherein said surface is more than 25% covered by the indentations.

26. The engine fluid flow path system according to claim 23 wherein the flow of fluid comprises combustion air.

27. The engine fluid flow path system according to claim 23 further comprising a throttle body with a housing having at least two walls that partially define the flow path, one of the two wall having a surface with a plurality of indentations spaced apart from each other.

28. The engine fluid flow path system according to claim 23 further comprising an exhaust system including an exhaust pipe having a surface with a plurality of indentations spaced apart from each other.

29. The engine fluid flow path system according to claim 23 wherein the intake system further comprises an air intake having a surface with a plurality of indentations spaced apart from each other.

30. A method for insulating a fluid from heat generated by an engine comprising the steps of:
connecting an induction tube from atmosphere to an engine;
providing a plurality of indentations spaced apart from each other on a surface of the induction tube;
drawing a flow of fluid over the surface;
forming a fluid layer of air proximate to the indentations when the fluid flows over the surface; and
insulating the flow of fluid from ambient heat such that any elevation in temperature of the fluid is reduced.

31. The method according to claim 30 wherein the surface is more than 25% covered by the indentations.

32. An engine fluid flow path system for insulating a fluid from heat generated by an engine comprising:
an intake system for transferring the fluid from atmosphere into the engine, said intake system including an induction tube having a surface with a plurality of indentations spaced apart from each other;
a flow of fluid over the surface; and
a fluid layer formed by air proximate to the indentations and caused by the presence of the indentations when the fluid flows over the surface, the fluid layer insulating the flow of fluid from ambient heat such that any elevation in temperature of the fluid is reduced.
